(19) United States
(12) Patent Application Publication
(10) Pub. No.: US 2019/0005464 A1
(43) Pub. Date: Jan. 3, 2019

(54) SYSTEM AND METHOD FOR SCHEDULING VEHICLE MAINTENANCE SERVICES

(71) Applicant: Faraday&Future Inc., Gardena, CA (US)

(72) Inventors: John Henry Harris, III, San Gabriel, CA (US); Kameron Fraige Saad Buckhout, SR., Inglewood, CA (US)

(21) Appl. No.: 15/691,609

(22) Filed: Aug. 30, 2017

Related U.S. Application Data
(60) Provisional application No. 62/382,157, filed on Aug. 31, 2016.

(51) Int. Cl. G06Q 10/00; G07C 5/00; G05D 1/00; G07C 5/08; G06Q 10/10

(52) U.S. Cl. CPC G06Q 10/20; G07C 5/006; G06Q 10/1097; G07C 5/085; G05D 1/0088

(57) ABSTRACT

Systems and methods relating to controlling a vehicle maintenance scheduling system including an interval value are disclosed. A location is identified using one or more sensors included with the vehicle. An interval adjustment value is determined using the location. The interval value is updated using the interval adjustment value.

### CROSS-REFERENCE TO RELATED APPLICATIONS

This application claims the benefit of U.S. Provisional Application No. 62/382,157, filed Aug. 31, 2016, the entirety of which is hereby incorporated by reference.

### FIELD OF THE DISCLOSURE

The present invention relates to scheduling vehicle maintenance services, and more specifically to scheduling vehicle maintenance services using a determination of a location of the vehicle.

### BACKGROUND OF THE DISCLOSURE

Some modern vehicles include a vehicle control system, which is connected to or operatively coupled to a maintenance scheduling system which schedules or recommends maintenance services for the vehicle. For example, a maintenance scheduling system for an automobile could present via a dashboard display a recommendation that the vehicle's engine oil be changed after 500 more miles have been driven, or that vehicle's tires be rotated in three weeks. As another example, a maintenance scheduling system for an automobile could automatically schedule general maintenance services every twelve months. As another example, a maintenance scheduling system could recommend that maintenance services be performed immediately. In many maintenance scheduling systems, the schedules or recommendations are based on one-size-fits-all estimates of appropriate intervals between vehicle maintenance, such as an automobile manufacturer's estimate of how many miles a typical driver will drive before requiring an oil change or other maintenance services. However, these estimates do not reflect that the intervals between which vehicle systems require maintenance can fluctuate based on factors relating to the specific operation of the vehicle: for example, a car driven on rough terrain in inclement weather will require more frequent maintenance than a car driven under blue skies on freshly paved roads. The estimates may thus be inaccurate, and the value of the maintenance scheduling system will be limited accordingly. It is an objective of the present invention to improve vehicle maintenance scheduling systems by using additional sources of input, such as data representing the location of the vehicle—obtainable via sensors and systems, such as GPS, on many vehicles—to more accurately calculate intervals between recommended vehicle maintenance.

### SUMMARY OF THE DISCLOSURE

An example of the present invention is directed to a vehicle using location data to update an interval value in a vehicle maintenance scheduling system. Location data may include a vehicle's current position or orientation in a world coordinate system. In some examples, location data can be obtained using a sensor such as a GPS receiver. In some examples, location data may be obtained from cellular data signals or Wi-Fi signals. In one aspect of the invention, location data is used to identify other data related to the vehicle's location, which data is then used to update an interval value in a vehicle maintenance scheduling system. In some examples, location data can be used to identify local map data, which may include data that relates geographic features to coordinates in a world coordinate system, which local map data can then be used to update an interval value in a vehicle maintenance scheduling system. In some examples, location data can be used to identify local real-time data such as current traffic conditions or weather conditions, which local real-time data can then be used to update an interval value in a vehicle maintenance scheduling system. In some examples, location data can be used to identify route data, such as the vehicle's position on a desired travel route between two points, which route data can then be used to update an interval value in a vehicle maintenance scheduling system. In some examples, location data can be used to identify local crowd data, which may include data (such as speeds and driving system settings at that location) supplied by other vehicles or drivers, which local crowd data can then be used to update an interval value in a vehicle maintenance scheduling system.

In one aspect of the invention, the interval value is the remaining interval until maintenance services should be performed, and in some examples, the vehicle maintenance scheduling system uses this interval value to recommend or schedule such services. In some examples, the interval value is a vehicle mileage, representing the number of additional miles a vehicle is to be driven before maintenance services are required, and the vehicle maintenance scheduling system will recommend that such services be performed after the vehicle has driven a number of miles equal to the interval value. In some examples, the interval value is a time value, representing the amount of time that will elapse before maintenance services are required, and the vehicle maintenance scheduling system will recommend that such services be performed after a period of time equal to the interval value has elapsed.

### BRIEF DESCRIPTION OF THE DRAWINGS

FIG. 1 illustrates a system block diagram of a vehicle control system according to examples of the disclosure.

FIG. 2 illustrates an example scenario in which a vehicle maintenance scheduling system recommends performing maintenance services after an interval value has elapsed.

FIG. 3 illustrates a block diagram of a process executed by a processor in an example of the invention.

FIGS. 4A through 4D illustrate example block diagrams of processes executed by a processor in examples of the invention.

### DETAILED DESCRIPTION

Examples of the present invention are directed to using location data relating to a vehicle, such as may be obtained by a sensor or a positioning system, such as an onboard or otherwise operatively coupled Global Positioning System (“GPS”), to identify an input of a driving system. In some examples, the location data is used to identify map data, real-time data, route data, and/or crowd data related to the vehicle's location, which data is then used to update the interval value.

A vehicle according to the present invention may be an autonomous vehicle. As used herein, an autonomous vehicle can be a vehicle which performs one or more autonomous driving operations. Autonomous driving can refer to fully autonomous driving, partially autonomous driving, and/or driver assistance systems.

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

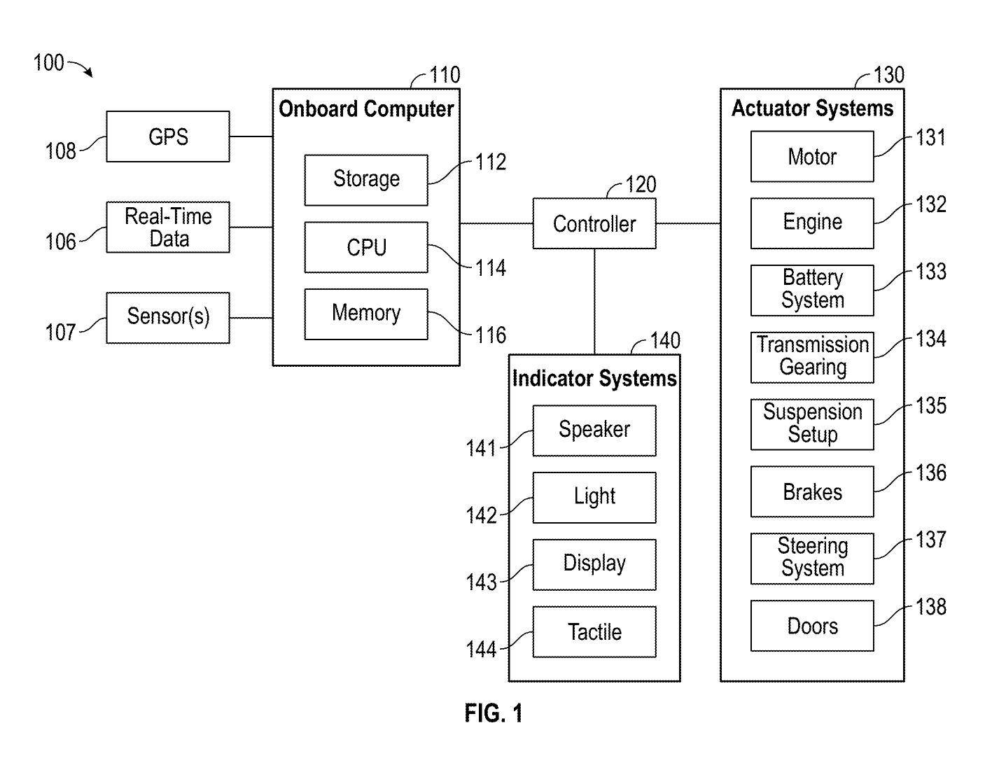

FIG. 1 illustrates an exemplary system block diagram of vehicle control system 100 according to examples of the disclosure. System 100 can be incorporated into a vehicle, such as a consumer automobile. Other example vehicles that may incorporate the system 100 include, without limitation, airplanes, boats, or industrial automobiles. Vehicle control system 100 can include one or more receivers 106 for real-time data, such as current traffic patterns or current weather conditions. Vehicle control system 100 can also include one or more sensors 107 (e.g., microphone, optical camera, radar, ultrasonic, LIDAR, etc.) that either individually or collectively are capable of detecting various characteristics of the vehicle's surroundings, such as the position and orientation of objects relative to the vehicle or a sensor; and a satellite (e.g., GPS system 108) capable of determining an approximate position of the vehicle relative to a world coordinate system.

Data from one or more sensors (e.g., LIDAR data, radar data, ultrasonic data, camera data, etc.) can be fused together. This fusion can occur at one or more electronic control units (ECUs). The particular ECU(s) that are chosen to perform data fusion can be based on an amount of resources (e.g., processing power and/or memory) available to the one or more ECUs, and can be dynamically shifted between ECUs and/or components within an ECU (since an ECU can contain more than one processor) to optimize performance.

Vehicle control system 100 can include an onboard computer 110 that is coupled to the receivers 106, sensors 107 and satellite (e.g., GPS) receiver 108, and that is capable of receiving data from the receivers 106, sensors 107 and satellite (e.g., GPS) receiver 108. The onboard computer 110 can include storage 112, memory 116, and a processor 114. Processor 114 can perform any of the methods described herein. Additionally, storage 112 and/or memory 116 can store data and instructions for performing any of the methods described herein. Storage 112 and/or memory 116 can be any non-transitory computer readable storage medium, such as a solid-state drive or a hard disk drive, among other possibilities. The vehicle control system 100 can also include a controller 120 capable of controlling one or more aspects of vehicle operation, such as indicator systems 140 and actuator systems 130.

In some examples, the vehicle control system 100 can be connected or operatively coupled to (e.g., via controller 120) one or more driving systems, such as actuator systems 130 in the vehicle and indicator systems 140 in the vehicle. The one or more actuator systems 130 can include, but are not limited to, a motor 131 or engine 132, battery system 133, transmission gearing 134, suspension setup 135, brakes 136, steering system 137 and door system 138. The vehicle control system 100 can control, via controller 120, one or more of these actuator systems 130 during vehicle operation; for example, to open or close one or more of the doors of the vehicle using the door actuator system 138, or to control the vehicle during autonomous or semi-autonomous driving or parking operations, using the motor 131 or engine 132, battery system 133, transmission gearing 134, suspension setup 135, brakes 136 and/or steering system 137, etc. The one or more indicator systems 140 can include, but are not limited to, one or more speakers 141 in the vehicle (e.g., as part of an entertainment system in the vehicle), one or more lights 142 in the vehicle, one or more displays 143 in the vehicle (e.g., as part of a control or entertainment system in the vehicle) and one or more tactile actuators 144 in the vehicle (e.g., as part of a steering wheel or seat in the vehicle). The vehicle control system 100 can control, via controller 120, one or more of these indicator systems 140 to provide indications to a driver of a vehicle maintenance scheduling system. For example, one or more displays 143 in the vehicle could indicate to the driver that, according to the vehicle maintenance scheduling system, the vehicle's tires should be rotated in 500 miles.

In one example, input data from sensors 107 and/or GPS receiver 108 can be used to identify a location of a vehicle relative to a world coordinate system, which location is then used to improve the operation of a maintenance scheduling system of the vehicle. Examples of the disclosure are directed to using a location system, such as a GPS location system, to identify a location of the vehicle, and further to using that location to update an interval value of the maintenance scheduling system, allowing the maintenance scheduling system to take the vehicle's location into account during its operation. The disclosure is not limited to the use of GPS to identify a location. Some examples may use other systems or techniques for identifying a vehicle's location, for example, triangulation using cellular data signals or Wi-Fi signals. As used herein, a sensor includes receivers such as GPS receivers.

As used herein, a maintenance scheduling system is any system which identifies when maintenance services should be performed on a vehicle, and either presents to a driver when such services should be performed, or schedules such services autonomously. Maintenance services may include preventative services, such as rotating the tires on a car, which are intended to prolong a vehicle's useful operation; replacement services, such as replacing parts that have reached the end of their useful lives; and/or repair services, such as fixing vehicle systems that are no longer fully functional. A maintenance scheduling system may identify that maintenance services are needed after an interval value has elapsed. A maintenance scheduling system may identify that maintenance services are needed immediately. A maintenance scheduling system may identify specific maintenance services that are needed, or may identify generally that maintenance services should be performed. The disclosure is not limited to any particular type of maintenance scheduling system, nor to any particular type of maintenance services.

As used herein, an interval value is a value stored by a maintenance scheduling system to represent an interval between a first point and a second point at which maintenance services should be performed. An interval value may be a time value, such as a number of days that will elapse before maintenance services should be performed, or a usage value, such as a number of miles that the vehicle will drive before maintenance services should be performed. An interval value less than or equal to zero may reflect that maintenance services should be performed immediately. The interval value may change as the maintenance scheduling system updates the interval value. An interval value can be represented in a computer system as a variable stored in a register or in a memory. The disclosure is not limited to any particular type or format of interval value, nor is the disclosure limited to any type of unit used to represent an interval value. The disclosure is also not limited to any form in which the interval value is stored, presented, or represented.

As used herein, an interval adjustment value is a value stored by a maintenance scheduling system that may directly or indirectly affect an interval value. In some examples, an interval adjustment value is a multiplication factor, which may be multiplied by an interval value (or a value used to increase or decrease an interval value) to change the interval value. In some examples, an interval adjustment value is a sum, which may be added to an interval value (or a value used to increase or decrease an interval value) to change the interval value. In some examples, an interval adjustment value is a value which directly sets the interval value. For instance, an interval adjustment value of zero miles may be used to set the interval value to zero, indicating that maintenance services should be performed immediately. The disclosure is not limited to any particular type or format of interval adjustment value, nor is the disclosure limited to any type of unit used to represent an interval adjustment value. The disclosure is also not limited to any form in which the interval adjustment value is stored, presented, or represented.

It should be appreciated that in some embodiments a learning algorithm can be implemented such as an as a neural network (deep or shallow) and be applied instead of, or in conjunction with another algorithm described herein to solve a problem, reduce error, and increase computational efficiency. Such learning algorithms may implement a feedforward neural network (e.g., a convolutional neural network) and/or a recurrent neural network, with structured learning, unstructured learning, and/or reinforcement learning. In some embodiments, backpropagation may be implemented (e.g., by implementing a supervised long short-term memory recurrent neural network, or a max-pooling convolutional neural network which may run on a graphics processing unit). Moreover, in some embodiments, unstructured learning methods may be used to improve structured learning methods. Moreover still, in some embodiments, resources such as energy and time may be saved by including spiking neurons in a neural network (e.g., neurons in a neural network that do not fire at each propagation cycle).

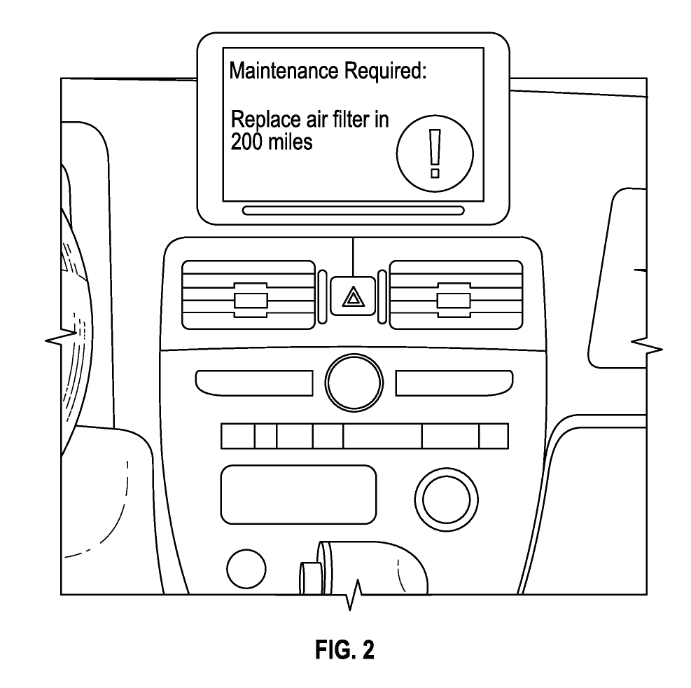

FIG. 2 illustrates an example of a vehicle maintenance scheduling system included in a vehicle, shown from the perspective of a driver of the vehicle. In the example shown, a dashboard display of the vehicle presents to the driver that maintenance services are required, and more specifically, that the vehicle's air filter will need to be replaced after 200 more miles have been driven. In this example, 200 miles represents an interval value stored in the maintenance scheduling system; once the vehicle has driven 50 more miles, the interval value will be updated to 150 miles. In other examples, the interval value is represented by a period of time, such as a number of days.

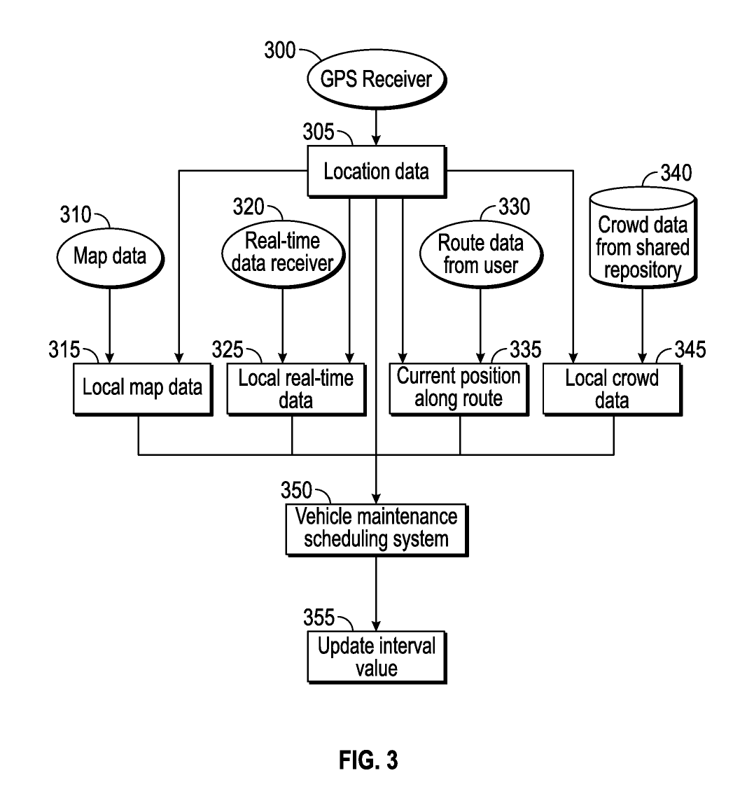

FIG. 3 illustrates a block diagram showing an example process executed by a processor included in a vehicle in an example of the invention. It will be appreciated by those skilled in the art that the example process shown in FIG. 3 could be implemented as multiple processes, executed by one or more processors, using known techniques and without departing from the present invention. In the example process shown, the processor obtains the vehicle's location data 305 from GPS receiver 300, which is configured to identify the location of the vehicle using the GPS system and to output data relating to that location.

In the example process shown in FIG. 3, map data 310 is a set of data that relates geographic features of a mapped region to geographic coordinates, such as coordinates obtained from a GPS system or a survey. Map data may include, for example, topographical data, such as data relating to terrain and natural surfaces; structural data, such as data relating to roads, buildings, signage, and man-made structures; political data, such as data relating to cities, towns, and other political divisions, or to legal information such as local driving laws and speed limits; or socioeconomic data, such as data relating to places of business. In some examples, map data is commercially available map data, such as sold by vendors such as TomTom, HERE, and Sanborn. In some examples, map data is provided by the vehicle, the vehicle's manufacturer, and/or third parties.

In the example process shown in FIG. 3, the processor uses location data 305 to identify, from map data 310, local map data 315 that is relevant to the vehicle's current location. For example, local map data 315 could include map data identifying local roads (including a road on which the vehicle is currently driving, and including the type of road and the quality of the road surface), nearby businesses (such as restaurants or gas stations), and local speed limits. Local map data 315 can be identified from map data 310 by using location data 305 to identify a subset of map data 310 that relates to features in a mapped region near the current location.

In the example process shown in FIG. 3, real-time data receiver 320 is a receiver, such as receiver 106 shown in FIG. 1, configured to receive data, such as traffic conditions, weather conditions, or road conditions, that may vary continuously. In some examples, real-time data is received from a broadcast service, such as the World Area Forecast System provided by the United States National Weather Service. In some examples, receiver 106 is configured to receive real-time data via the internet, and the real-time data is provided by an internet service.

In the example process shown in FIG. 3, the processor uses location data 305 to identify, from real-time data receiver 320, local real-time data 325 that is relevant to the vehicle's current location. Local real-time data 325 could indicate, for example, that inclement weather is expected at the vehicle's current location, that traffic at the vehicle's location is unusually heavy, or that a road on which the vehicle is currently traveling is under construction.

In the example process shown in FIG. 3, route data 330 is provided by a driver and indicates a route the driver intends to travel. For example, route data 330 could include geographic coordinates of a starting point and a target destination. In the example process shown in FIG. 3, the processor uses location data 305 in combination with route data 330 to determine a current position 335 along the route indicated by the route data. For example, the processor could use location data 305 to determine that the vehicle is currently two miles from a driver's target destination, or that at current speeds, the vehicle is expected to reach the driver's target destination in five minutes.

In the example process shown in FIG. 3, crowd data 340 is data relating to a specific geographical location that is provided by other vehicles, drivers, or users and made available from a shared repository, such as a remote server configured to transmit and receive data via the internet. Crowd data 340 can include data of interest to other vehicles or drivers. For example, crowd data 340 could indicate that a significant number of drivers shifted into low gear when approaching a certain geographical location, experienced a drop in fuel efficiency at a certain geographical location, or engaged assistive driving systems at a certain geographical location. In some examples, crowd data includes interval values or interval adjustment values for a vehicle maintenance scheduling system. In some examples, a vehicle is configured to provide crowd data to a shared repository, with or without the driver's interaction, using techniques known in the art, where it can be later accessed by other vehicles or users. In some examples, crowd data is provided via telemetry device, such as a mobile phone with a location system such as GPS. In some examples, crowd data is provided manually by a user. In some examples, a shared repository is not utilized, and crowd data is provided from a source to a receiver vehicle via means such as a peer-to-peer network or a direct connection. It will be appreciated by those skilled in the art that many systems and methods for providing data, such as crowd data, are known in the art and can be used within the scope of the present invention.

In the example process shown in FIG. 3, the processor uses location data 305 to identify local crowd data 345 from crowd data 340. For example, local crowd data 345 can be identified from crowd data 340 by using location data 305 to identify a subset of crowd data 340 that relates to geographic coordinates near the current location.

In the example process shown in FIG. 3, the processor is configured to update an interval value of vehicle maintenance scheduling system 350. At stage 355 of the example process shown in FIG. 3, the processor uses one or more of location data 305, local map data 315, local real-time data 325, current route position 335, and local crowd data 345 to update an interval value of maintenance scheduling system 350.

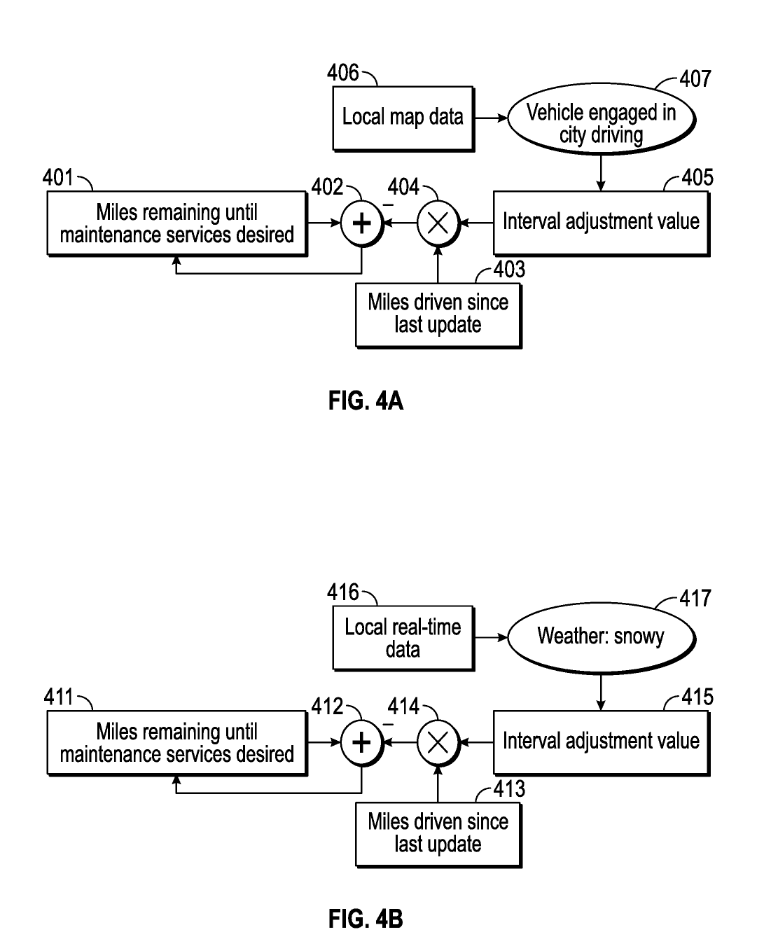

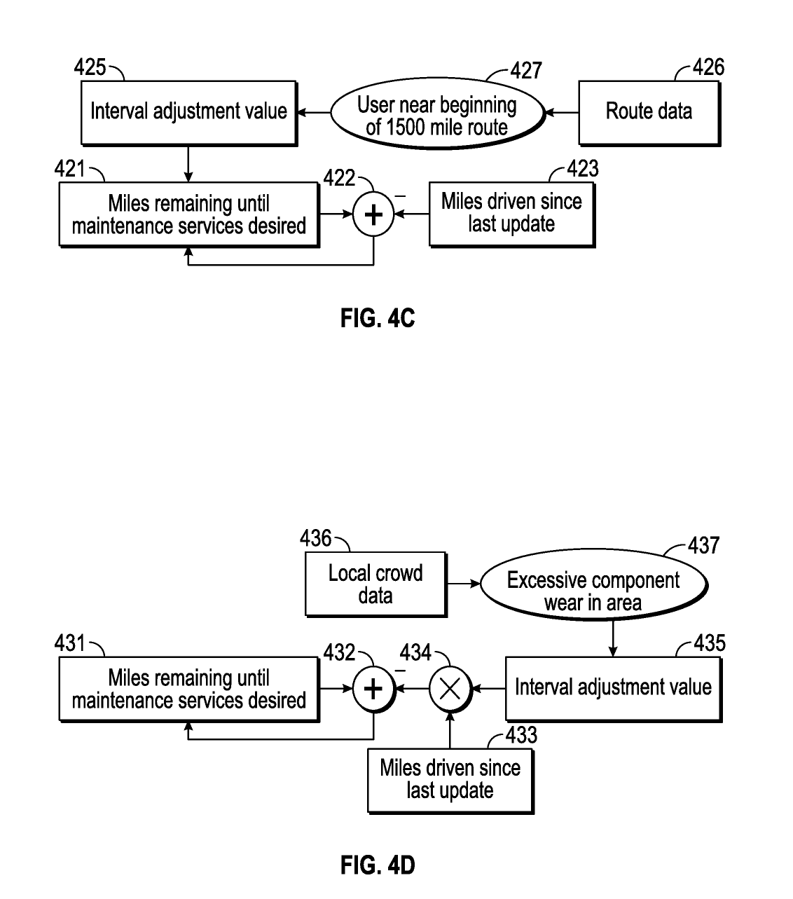

FIG. 4A is an example process illustrating how, in the example process shown in FIG. 3, the processor may use local map data to update an interval value of a vehicle maintenance scheduling system included in a vehicle. In this example, interval value 401 represents the interval remaining until maintenance services are to be performed; here, the interval value is a number of miles to be driven. In an iteration of the example process shown in FIG. 4A, the interval value 401 is decreased (at summing stage 402) by the number of miles driven 403 since the previous iteration, multiplied (at multiplier stage 404) by an interval adjustment value 405. (In this example, the interval adjustment value is a multiplication factor to be multiplied by a number of miles; however, in other examples, the interval adjustment value could be a sum to be added to a number of miles, or some other value. Similarly, the interval value may be a period of time, or some other type of value, rather than a number of miles.) In this example, an interval adjustment value of 1 would indicate no adjustment to the number of miles driven. At stage 407 of the example process shown in FIG. 4A, it is identified that local map data 406 indicates, for example using data relating to nearby roads, city boundaries, or average vehicle density in a region, that the vehicle is engaged in “city” driving, which can be characterized by stop-and-go vehicle operation and typically results in more wear on vehicle components than does “highway” driving. A vehicle engaged primarily in city driving may require maintenance services sooner than a vehicle engaged primarily in highway driving. In the example process, the information identified at stage 407 is used to determine interval adjustment value 405. As one example, the interval adjustment value 405 may be determined using techniques known in the art to be 1.2, representing a 20 percent increase in component wear per mile due to city driving. In the example process shown in FIG. 4A in which the interval adjustment value is 1.2, the miles driven 403 will be multiplied at stage 404 by 1.2, which will result (via summing stage 402) in a larger decrease in the interval value 401 than if the interval adjustment value had been lower. This reflects, in the example, that the vehicle maintenance scheduling system will recommend maintenance sooner for a vehicle engaged in city driving than for a vehicle engaged in highway driving.

FIG. 4B is an example process illustrating how, in the example process shown in FIG. 3, the processor may use local real-time data to update an interval value of a vehicle maintenance scheduling system included in a vehicle. In this example, interval value 411 represents the interval remaining until maintenance services are required; here, the interval value is a number of miles to be driven. In an iteration of the example process shown in FIG. 4B, the interval value 411 is decreased (at summing stage 412) by the number of miles driven 413 since the previous iteration, multiplied (at multiplier stage 414) by an interval adjustment value 415. (In this example, the interval adjustment value is a multiplication factor to be multiplied by a number of miles; however, in other examples, the interval adjustment value could be a sum to be added to a number of miles, or some other value. Similarly, the interval value may be a period of time, or some other type of value, rather than a number of miles) In this example, an interval adjustment value of 1 would indicate no adjustment to the number of miles driven. At stage 417 of the example process shown in FIG. 4B, it is identified that local real-time data 416 indicates, for example using data broadcast by a weather service, that the vehicle is currently driving in snowy weather conditions, which generally cause more wear on vehicle components than do normal weather conditions. Driving in snowy weather may cause a vehicle to require maintenance services sooner than it would otherwise. In the example process, the information identified at stage 417 is used to determine interval adjustment value 415. As one example, the interval adjustment value 415 may be determined using techniques known in the art to be 1.5, representing a 50 percent increase in component wear per mile due to driving in snowy weather. In the example shown in FIG. 4B in which the interval adjustment value is 1.5, the miles driven 413 will be multiplied at stage 414 by 1.5, which will result (via summing stage 412) in a larger decrease in the interval value 411 than if the interval adjustment value had been lower. This reflects, in the example, that the vehicle maintenance scheduling system will recommend maintenance sooner for a vehicle driving in snowy weather than for a vehicle that avoids snowy weather.

FIG. 4C is an example process illustrating how, in the example process shown in FIG. 3, the processor may use route data to update an interval value of a vehicle maintenance scheduling system included in a vehicle. In this example, interval value 421 represents the interval remaining until maintenance services are required; here, the interval value is a number of miles to be driven. In an iteration of the example process shown in FIG. 4C, the interval value 421 is decreased (at summing stage 422) by the number of miles driven 423 since the previous iteration. (In various examples, interval value may be a period of time, or some other type of value, rather than a number of miles) In the example process shown in FIG. 4C, the interval value is also directly affected by an interval adjustment value that directly sets the interval value to a specified value. At stage 427 of the example shown in FIG. 4C, it is identified that route data 426 indicates, for example by using the starting and ending locations of the user's route, that the driver is currently near the beginning of a lengthy 1500 mile route through rough terrain. It may be recommended that maintenance services be performed at the beginning of a long route through rough terrain, regardless of other factors such as the current amount of wear on vehicle components. In the example shown in FIG. 4C, the information identified at stage 427 is used to determine interval adjustment value 425. In some examples, the interval adjustment value 425 may be determined using techniques known in the art to be zero, representing that the interval value 421 should be set to zero, with the result that the vehicle maintenance scheduling system may recommend that maintenance services be performed immediately, regardless of other factors, such as the miles driven since a previous update. This reflects, in the example, that the vehicle maintenance scheduling system will recommend immediate maintenance for a vehicle setting out on a long route through rough terrain.

FIG. 4D is an example process illustrating how, in the example process shown in FIG. 3, the processor may use local crowd data to update an interval value of a vehicle maintenance scheduling system included in a vehicle. In this example, interval value 431 represents the interval remaining until maintenance services are required; here, the interval value is a number of miles to be driven. In an iteration of the example process shown in FIG. 4D, the interval value 431 is decreased (at summing stage 432) by the number of miles driven 433 since the previous iteration, multiplied (at multiplier stage 434) by an interval adjustment value 435. (In this example, the interval adjustment value is a multiplication factor to be multiplied by a number of miles; however, in other examples, the interval adjustment value could be a sum to be added to a number of miles, or some other value. Similarly, the interval value may be a period of time, or some other type of value, rather than a number of miles) In this example, an interval adjustment value of 1 would indicate no adjustment to the number of miles driven. At stage 437 of the example process shown in FIG. 4D, it is identified that local crowd data 436 indicates, for example using vehicle component failure data uploaded to a stored repository by other vehicles, that the vehicle is currently driving in a region that causes excessive wear on vehicle components. Excessive component wear may cause a vehicle to require maintenance services sooner than it would otherwise. In the example process, the information identified at stage 437 is used to determine interval adjustment value 435. In some examples, the interval adjustment value 435 may be determined using techniques known in the art to be 1.1, representing a 10 percent increase in component wear per mile due to driving in a region known to cause an increase in component wear. In the example shown in FIG. 4D in which the interval adjustment value is 1.1, the miles driven 433 will be multiplied at stage 434 by 1.1, which will result (via summing stage 412) in a larger decrease in the interval value 431 than if the interval adjustment value had been lower. This reflects, in the example, that the vehicle maintenance scheduling system will recommend maintenance sooner for a vehicle driving in a region known to result in excessive component wear.

Some examples of the disclosure are directed to a method of controlling a vehicle maintenance scheduling system including an interval value, the method comprising: identifying a location using one or more sensors included with a vehicle; determining, using the location, an interval adjustment value; and updating the interval value using the interval adjustment value. Additionally or alternatively to one or more of the examples disclosed above, in some examples, the method further comprises identifying, using the location, map data relating to the location, and the interval adjustment value is determined using the map data. Additionally or alternatively to one or more of the examples disclosed above, in some examples, the method further comprises identifying, using the location, real-time data relating to the location, and the interval adjustment value is determined using the real-time data. Additionally or alternatively to one or more of the examples disclosed above, in some examples, the method further comprises identifying, using the location, route data relating to the location, and the interval adjustment value is determined using the route data. Additionally or alternatively to one or more of the examples disclosed above, in some examples, the method further comprises identifying, using the location, data provided by one or more other vehicles or users relating to the location, and the interval adjustment value is determined using the data provided by one or more other vehicles or users. Additionally or alternatively to one or more of the examples disclosed above, in some examples, the data provided by one or more other vehicles or users is obtained from a shared repository. Additionally or alternatively to one or more of the examples disclosed above, in some examples, the method further comprises identifying, using the location, data provided by a telemetry device relating to the location, and the interval adjustment value is determined using the data provided by the telemetry device. Additionally or alternatively to one or more of the examples disclosed above, in some examples, the method further comprises communicating an interval adjustment value to a shared repository. Additionally or alternatively to one or more of the examples disclosed above, in some examples, the method further comprises communicating an interval adjustment value to another vehicle. Additionally or alternatively to one or more of the examples disclosed above, in some examples, the vehicle is an autonomous vehicle.

Some examples of the disclosure are directed to a vehicle maintenance scheduling system comprising: one or more sensors included with a vehicle, the one or more sensors configured to present sensor data; one or more processors coupled to the one or more sensors; a memory including instructions, which when executed by the one or more processors, cause the one or more processors to perform a method comprising: storing an interval value in a memory; identifying a location using the one or more sensors; determining, using the location, an interval adjustment value; and updating the interval value using the interval adjustment value. Additionally or alternatively to one or more of the examples disclosed above, in some examples, the method further comprises identifying, using the location, local map data relating to the location, and the interval adjustment value is determined using the local map data. Additionally or alternatively to one or more of the examples disclosed above, in some examples, the method further comprises identifying, using the location, local real-time data relating to the location, and the interval adjustment value is determined using the local real-time data. Additionally or alternatively to one or more of the examples disclosed above, in some examples, the method further comprises identifying, using the location, route data relating to the location, and the interval adjustment value is determined using the route data. Additionally or alternatively to one or more of the examples disclosed above, in some examples, the method further comprises identifying, using the location, data provided by one or more other vehicles or users relating to the location, and the interval adjustment value is determined using the data provided by one or more other vehicles or users.

Some examples of the disclosure are directed to a non-transitory machine-readable storage medium containing program instructions executable by a computer, the program instructions enabling the computer to perform: storing an interval value in a memory; identifying a location using one or more sensors included with a vehicle; determining, using the location, an interval adjustment value; and updating the interval value using the interval adjustment value. Additionally or alternatively to one or more of the examples disclosed above, in some examples, the program instructions further enable the computer to perform identifying, using the location, local map data relating to the location, and the interval adjustment value is determined using the local map data. Additionally or alternatively to one or more of the examples disclosed above, in some examples, the program instructions further enable the computer to perform identifying, using the location, local real-time data relating to the location, and the interval adjustment value is determined using the local real-time data. Additionally or alternatively to one or more of the examples disclosed above, in some examples, the program instructions further enable the computer to perform identifying, using the location, route data relating to the location, and the interval adjustment value is determined using the route data. Additionally or alternatively to one or more of the examples disclosed above, in some examples, the program instructions further enable the computer to perform identifying, using the location, data provided by one or more other vehicles or users relating to the location, and the interval adjustment value is determined using the data provided by one or more other vehicles or users.

Although examples of this disclosure have been fully described with reference to the accompanying drawings, it is to be noted that various changes and modifications will become apparent to those skilled in the art. Such changes and modifications are to be understood as being included within the scope of examples of this disclosure as defined by the appended claims.

1. A method of controlling a vehicle maintenance scheduling system including an interval value, the method comprising:
identifying a location using one or more sensors included with a vehicle;
determining, using the location, an interval adjustment value; and
updating the interval value using the interval adjustment value.

2. The method of claim 1, further comprising identifying, using the location, map data relating to the location, and wherein the interval adjustment value is determined using the map data.

3. The method of claim 1, further comprising identifying, using the location, real-time data relating to the location, and wherein the interval adjustment value is determined using the real-time data.

4. The method of claim 1, further comprising identifying, using the location, route data relating to the location, and wherein the interval adjustment value is determined using the route data.

5. The method of claim 1, further comprising identifying, using the location, data provided by one or more other vehicles or users relating to the location, and wherein the interval adjustment value is determined using the data provided by one or more other vehicles or users.

6. The method of claim 5, wherein the data provided by one or more other vehicles or users is obtained from a shared repository.

7. The method of claim 1, further comprising identifying, using the location, data provided by a telemetry device relating to the location, and wherein the interval adjustment value is determined using the data provided by the telemetry device.

8. The method of claim 1, further comprising communicating an interval adjustment value to a shared repository.

9. The method of claim 1, further comprising communicating an interval adjustment value to another vehicle.

10. The method of claim 1, wherein the vehicle is an autonomous vehicle.

11. A vehicle maintenance scheduling system comprising:
one or more sensors included with a vehicle, the one or more sensors configured to present sensor data;
one or more processors coupled to the one or more sensors;
a memory including instructions, which when executed by the one or more processors, cause the one or more processors to perform a method comprising:
storing an interval value in a memory;
identifying a location using the one or more sensors;
determining, using the location, an interval adjustment value; and
updating the interval value using the interval adjustment value.

12. The system of claim 11, wherein the method further comprises identifying, using the location, local map data relating to the location, and wherein the interval adjustment value is determined using the local map data.

13. The system of claim 11, wherein the method further comprises identifying, using the location, local real-time data relating to the location, and wherein the interval adjustment value is determined using the local real-time data.

14. The system of claim 11, wherein the method further comprises identifying, using the location, route data relating to the location, and wherein the interval adjustment value is determined using the route data.

15. The system of claim 11, wherein the method further comprises identifying, using the location, data provided by one or more other vehicles or users relating to the location, and wherein the interval adjustment value is determined using the data provided by one or more other vehicles or users.

16. A non-transitory machine-readable storage medium containing program instructions executable by a computer, the program instructions enabling the computer to perform:
storing an interval value in a memory;
identifying a location using one or more sensors included with a vehicle;
determining, using the location, an interval adjustment value; and
updating the interval value using the interval adjustment value.

17. The non-transitory machine-readable storage medium of claim 16, wherein the program instructions further enable the computer to perform identifying, using the location, local map data relating to the location, and wherein the interval adjustment value is determined using the local map data.

18. The non-transitory machine-readable storage medium of claim 16, wherein the program instructions further enable the computer to perform identifying, using the location, local real-time data relating to the location, and wherein the interval adjustment value is determined using the local real-time data.

19. The non-transitory machine-readable storage medium of claim 16, wherein the program instructions further enable the computer to perform identifying, using the location, route data relating to the location, and wherein the interval adjustment value is determined using the route data.

20. The non-transitory machine-readable storage medium of claim 16, wherein the program instructions further enable the computer to perform identifying, using the location, data provided by one or more other vehicles or users relating to the location, and wherein the interval adjustment value is determined using the data provided by one or more other vehicles or users.
